(19) United States
(12) Patent Application Publication
(10) Pub. No.: US 2021/0367863 A1
(43) Pub. Date: Nov. 25, 2021

(54) MANAGEMENT DEVICE AND NETWORK MANAGEMENT METHOD

(71) Applicant: Nippon Telegraph and Telephone Corporation, Tokyo (JP)

(72) Inventors: Motomu Nakajima, Tokyo (JP); Yuichi Suto, Tokyo (JP); Yuji Soejima, Tokyo (JP); Aiko OI, Tokyo (JP); Kosuke Sakata, Tokyo (JP)

(21) Appl. No.: 17/257,129

(22) PCT Filed: Jun. 28, 2019
(86) PCT No.: PCT/JP2019/025799

§ 371 Date: Dec. 30, 2020

(30) Foreign Application Priority Data
Jul. 5, 2018 (JP) 2018-128019

(51) Int. Cl. H04L 12/24

(52) U.S. Cl. CPC H04L 41/5051; H04L 41/22

(57) ABSTRACT

[Problem] To improve performance of NS management.

[Solution] A management apparatus M for managing an NS constructed on an NW including a virtualization area and a non-virtualization area includes a request reception unit 11 configured to acquire an NS generation order including an input parameter required for designating a server-side apparatus and an NW-side apparatus, from an external apparatus, and a catalog DB 17 that stores a catalog serving as a template of the NS. The catalog includes an NSD being a portion in which a configuration of the NS is described and having a plurality of types of information sets defining a group of constituent elements of the NS in a selectable manner. The management apparatus M further includes a scenario management unit 12 configured to generate, if a specific parameter for individually designating a group of constituent elements of the NS by another system U1 without selecting the plurality of types of information sets is included in the input parameter, the NS by using the individually designated group of constituent components of the NS, and to otherwise generate the NS by using an information set selected by the other system U1.

### TECHNICAL FIELD

The present invention relates to a management apparatus and a network management method.

Herein, “NW” is used as a term representing a network. “NS” is used as a term representing a network service. “DB” is used as a term representing a database. “IF” is used as a term representing an interface.

### BACKGROUND ART

Patent Literature 1 discloses “a management apparatus that manages a Network Service (NS) constructed on a NetWork (NW) including a core NW serving as a virtualization area and an access NW serving as a non-virtualization area. The management apparatus includes a service management unit that manages the NS, a server-side apparatus management unit that manages server-side apparatuses disposed on the NW, and an NW-side apparatus management unit that manages NW-side apparatuses disposed on the NW. The service management unit includes a request reception unit that acquires, from the outside, an NS generation request including input parameters required for designating the server-side apparatuses and the NW-side apparatuses when the NS is provided, a catalog management unit that manages a catalog serving as a template of the NS, a resource adjustment unit that adjusts resources of the server-side apparatuses and resources of the NW-side apparatuses, a workflow unit that generates, in a case where the catalog is selected, a slice for realizing the NS by generating the resources of the designated server-side apparatuses and the resources of the designated NW-side apparatuses according to the input parameters, and an NS lifecycle management unit that manages a lifecycle of the NS”.

Non Patent Literature 1 discloses a selection of NS Deployment Flavour (NsDf) as a method of a control request from an external apparatus for NS management for the control disclosed in Patent Literature 1.

### CITATION LIST

### Patent Literature

Patent Literature 1: JP 2017-143452 A (Claim 1)

### Non Patent Literature

Non Patent Literature 1: “Annex B: Word format presentation of the NFV Information Model”, ETSI GR NFV-IFA 015 V2.1.2; January 2017, [Searched on Jul. 4, 2018], Internet <URL: https://www.etsi.org/deliver/etsi_gr/NFV-IFA/001_099/015/02.01.02_60/>

### SUMMARY OF THE INVENTION

### Technical Problem

However, in the selection of NS Deployment Flavour in Non Patent Literature 1, it is not possible to provide a detailed designation in a request from an external apparatus (it is not possible to individually designate a specific resource for physical resource optimization, for example), and therefore, there is left room for improvement in performance of the NS management.

Thus, in view of the above circumstances, an object of the present invention is to improve performance of NS management.

### Means for Solving the Problem

To solve the problem, an invention according to claim 1 is an management apparatus for managing a network service (NS) constructed on a network (NW) including a core NW serving as a virtualization area and an access NW serving as a non-virtualization area, in which the NW includes a server-side apparatus and an NW-side apparatus when the NS is provided, and the management apparatus includes a request reception unit configured to acquire an NS generation order including an input parameter required for designating the server-side apparatus and the NW-side apparatus, from an external apparatus, and a catalog database (DB) that stores a catalog serving as a template of the NS. The catalog includes an NS Descriptor (NSD) being a portion where a configuration of the NS is described and having a plurality of types of information sets for defining a group of constituent elements of the NS in a selectable manner, and the management apparatus further includes a scenario management unit configured to generate, if a specific parameter for individually designating a group of constituent elements of the NS by the external apparatus without selecting the plurality of types of information sets is included in the input parameter, the NS by using the individually designated group of constituent elements of the NS, and to generate, if the specific parameter is not included in the input parameter, the NS by using an information set selected by the external apparatus.

Furthermore, an invention according to claim 3 is a network management method in a management apparatus for managing an NS constructed on an NW including a core NW serving as a virtualization area and an access NW serving as a non-virtualization area, in which the NW includes a server-side apparatus and an NW-side apparatus when the NS is provided, and the management apparatus includes a catalog DB that stores a catalog serving as a template of the NS. The catalog includes an NSD being a portion where a configuration of the NS is described and including a plurality of types of information sets for defining a group of constituent elements of the NS in a selectable manner. The method includes acquiring an NS generation order including an input parameter required for designating the server-side apparatus and the NW-side apparatus, from an external apparatus, generating, if a first parameter in which a group of constituent elements of the NS is individually designated by the external apparatus without selecting the plurality of types of information sets is included in the input parameter, the NS by using the individually designated group of constituent elements of the NS, and generating, if the first parameter is not included in the input parameter, the NS by using an information set selected by the external apparatus.

According to the inventions described in claims 1 and 3, if the specific parameter that enables individual designation of the group of the constituent elements of the NS is included in the NS generation order, it is possible to provide a means of providing a detailed designation of the group of constituent elements of the NS, which is otherwise impossible to realize in the selection of the NS Deployment Flavour, to the external apparatus.

It is thus possible to improve performance of NS management.

An invention according to claim 2 is the management apparatus according to claim 1, in which the catalogue further includes a portion where an application utilized in the NS is described, a portion where a physical function utilized in the NS is described, and a portion where a connection relationship between applications utilized in the NS is described, and a portion where a link utilized in the NS is described.

An invention according to claim 4 is the network management method according to claim 3, in which the catalogue further includes a portion where an application utilized in the NS is described, a portion where a physical function utilized in the NS is described, and a portion where a connection relationship between applications utilized in the NS is described, and a portion where a link utilized in the NS is described.

According to the inventions described in claims 2 and 4, a portion where an application utilized in the NS is described, a portion where a physical function utilized in the NS is described, and a portion where a connection relationship between applications utilized in the NS is described, and a portion where a link utilized in the NS is described are included in the catalog, and thus, it is possible to specifically design the NS.

### Effects of the Invention

According to the present invention, it is possible to improve performance of NS management.

### BRIEF DESCRIPTION OF DRAWINGS

FIG. 1 is a functional configuration diagram of a management apparatus according to the present embodiment.

FIG. 2 is a diagram illustrating an NSD in detail.

FIG. 3 is a table showing an example of parameters that can be designated in NS generation/instantiation in a comparative example.

FIG. 4 is a table showing an example of parameters that can be designated in NS generation/instantiation in the present embodiment.

FIG. 5 is a flowchart of an NS generation order process.

### DESCRIPTION OF EMBODIMENTS

A mode for implementing the present invention (embodiment) will be described below with reference to the drawings.

A management apparatus M according to the present embodiment manages a core NW serving as a virtualization area and an access NW serving as a non-virtualization area. Specifically, the management apparatus M monitors devices disposed on the core NW and devices disposed on the access NW by collecting various information from these devices. An NW configuration is created by the devices disposed on the core NW and the devices disposed on the access NW.

The management apparatus M also manages a network service (NS) constructed on the NW including the core NW and the access NW. The NS can implement end to end (E2E) management between end points that are a terminal of an NS use side (user) and a service provider (Internet service provider (ISP), for example), via devices on an access NW and a core NW held on an NS providing side (a communication carrier, for example).

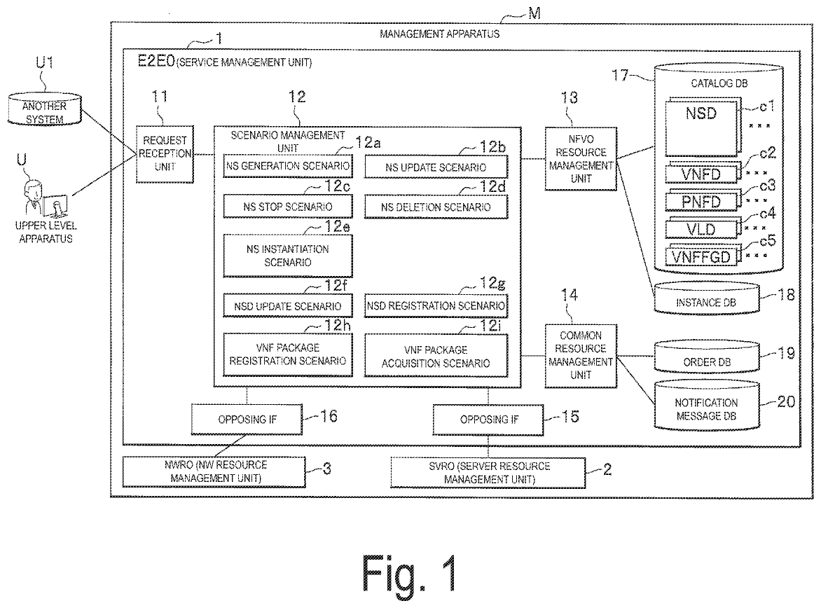

As illustrated in FIG. 1, the management apparatus M includes an end to end orchestrator (E2EO) (E2E orchestrator) 1 (service management unit), a server resource orchestrator (SVRO) 2 (server resource management unit), and a network resource orchestrator (NWRO) 3 (NW resource management unit).

The E2EO 1 is a functional unit that autonomously manages the NS provided to a user. The SVRO 2 manages resources of server-side apparatuses disposed on the NW including the core NW and the access NW.

The NWRO 3 manages resources of NW-side apparatuses disposed on the NW including the core NW and the access NW.
The E2EO 1, the SVRO 2, and the NWRO 3 operate in accordance with a request from an upper level apparatus U (external apparatus) operated by an operator or from another system U1 (external apparatus) having the identical function to the upper level apparatus U. Note that the other system U1 corresponds to an operation support system (OSS), a business support system (BSS), and an NW-artificial intelligence (NW-AI), and description about the upper level apparatus U applies to the other system U1, and therefore, the description about the upper level apparatus U is omitted unless otherwise specified, and a case where there is a request from the other system U1 mounted as NW-AI (autonomous request from a calculator not involving an operator) is described.

Each of the server-side apparatuses is an apparatus that executes the NS. The server-side apparatuses include, for example, a data center (DC), a general-purpose server disposed in the DC, and a virtual server, which is a virtual machine (VM), implemented by virtualizing the general-purpose server, but is not limited to these. One application (APL) can be disposed on the virtual server. The APL runs on the virtual server, so that a predetermined NS can be provided to the user. In the present embodiment, the APL may be referred to as virtual network function component (VNFc, NW function component) or a virtual network function (VNF, NW function) configured with one or more VNFc combined. The DC may be referred to as a Network Function Virtualization Infrastructure-Point of Presence (NFVI-PoP).

The NW-side apparatus is an apparatus that transfers data, for executing the NS, to another NW-side apparatus or to a server-side apparatus. The NW-side apparatuses include, for example, an optical line terminal (OLT, optical subscriber line termination apparatus), a core router, a layer 2 switch (L2SW), a layer 3 switch (L3SW), and network terminal equipment (NTE, network termination apparatus), but are not limited to these.

Details of E2EO 1

The E2EO 1 includes a request reception unit 11, a scenario management unit 12, a network function virtualization orchestrator (NFVO) resource management unit 13, a common resource management unit 14, opposing IFs 15 and 16, a catalog DB 17, an instance DB 18, an order DB 19, and a notification message DB 20.

The request reception unit 11 acquires an NS generation request output from the other system U1, as an order. The NS generation request is information for causing the management apparatus M to generate (construct) an NS. The NS generation request includes NS information in which descriptors of a plurality of types of server-side apparatuses and descriptors of a plurality of types of NW-side apparatuses are combined while being arranged as appropriate to represent a logical path set for a given NW configuration. The E2EO 1 maps these descriptors to respective server-side and NW-side apparatuses disposed on the NW. The NS generation request also includes an input parameter (hereinafter, may be simply referred to as “parameter”) required for designating the server-side apparatuses and the NW-side apparatuses used when the NS is provided using the logical path. Note that the order includes an order for updating the NS and an order for deleting the NS. The request reception unit 11 is specifically an Os-Ma-nfvo transmission and/or reception unit that functions as an interface between the OSS/BSS and the NFVO.

The scenario management unit 12 manages various scenarios for NS management. Each of the scenarios is a medium in which a processing procedure for processing an order is described. The scenario management unit 12 includes an NS generation scenario 12a, an NS update scenario 12b, an NS stop scenario 12c, an NS deletion scenario 12d, an NS instantiation scenario 12e, an NSD update scenario 12f, an NSD registration scenario 12g, a VNF package registration scenario 12h, and a VNF package acquisition scenario 12i.

The NS generation scenario 12a is a scenario for generating an NS from an NS generation order which is an order for generating the NS. The scenario management unit 12 generates NsIdentifier in response to an NS generation order acquired from the other system U1 and returns the NsIdentifier to the other system U1. The other system U1 may use the NsIdentifier to create an NS instantiating order which is an order for instantiating the NS.

The NS update scenario 12b is a scenario for updating an NS from an NS update order which is an order for updating the NS. The scenario management unit 12 may acquire, in response to the NS update order acquired from the other system U1, an instance linked to an instance ID in the order from the instance DB 18 and execute a control by the SVRO 2 (SVRO control) and a control by the NWRO 3 (NWRO control) to realize the update of the NS, based on the NS update scenario 12b. For example, in a case of an NS having a VNF, the NS update scenario 12b executes both the SVRO control and the NWRO control. In a case of an NS not having a VNF, the NS update scenario 12b executes the NWRO control.

The NS stop scenario 12c is a scenario for stopping an NS from an NS stop order which is an order for stopping the NS. The scenario management unit 12 may acquire, in response to the NS stop order acquired from the other system U1, an instance linked to an instance ID in the order from the instance DB 18 and execute SVRO control and NWRO control to realize stopping the NS, based on the NS stop scenario 12c. For example, in a case of an NS having a VNF, the NS stop scenario 12c executes both the SVRO control and the NWRO control. In a case of an NS not having a VNF, the NS stop scenario 12c executes the NWRO control.

The NS deletion scenario 12d is a scenario for deleting an NS from an NS deletion order which is an order for deleting the NS. Based on the NS deletion scenario 12d, the scenario management unit 12 acquires, in response to the NS deletion order acquired from the other system U1, an instance linked to an instance ID in the order from the instance DB 18 and instructs the SVRO 2 to delete the NS. The scenario management unit 12 deletes the instance from the instance DB 18. These procedures allow for the deletion of the NS.

The NS instantiation scenario 12e is a scenario for instantiating an NS from an NS instantiating order. The scenario management unit 12 may acquire an NS Descriptor (NSD) (which will be described in detail later) designated in the NS instantiating order acquired from the other system U1, from the catalog DB 17 via the NFVO resource management unit 13, and execute SVRO control and NWRO control to realize generation of the NS, based on the NS instantiation scenario 12e.

The NSD update scenario 12f is a scenario for updating an NSD. The scenario management unit 12 may read an NSD designated in the order from the other system U1 from the catalog DB 17 via the NFVO resource management unit 13 and update the NSD in accordance with an update request included in the order, based on the NSD update scenario 12f.

The NSD registration scenario 12g is a scenario for registering an NSD with the catalog DB 17. The scenario management unit 12 may register an NSD designated in the order from the other system U1 with the catalog DB 17 via the NFVO resource management unit 13, based on the NSD registration scenario 12g.

The VNF package registration scenario 12h is a scenario for registering a VNF package which is an application utilized in an NS, with the catalog DB 17. The VNF package is obtained by packaging a VNF and a VNFD (VNF Descriptor). The scenario management unit 12 may register a VNF package designated in the order from the other system U1 with the catalog DB 17 via the NFVO resource management unit 13, based on the VNF package registration scenario 12h.

The VNF package acquisition scenario 12i is a scenario for acquiring a VNF package from the catalogue DB 17. The scenario management unit 12 may acquire, from the catalog DB 17 via the NFVO resource management unit 13, the VNF package designated in the order from the other system U1, based on the VNF package acquisition scenario 12i.

The scenario management unit 12 may use an input parameter acquired by the request reception unit 11 to execute management of, not limited to, generation of an NS in accordance with various scenarios (numerals 12a to 12i).

Note that if acquiring, from the other system U1, an NS search order for searching an NS, the scenario management unit 12 may acquire an instance linked to an instance ID in the order from the instance DB 18 and respond NsInfo (return value of a Create NS Identifier order representing an NS generation) to the other system U1.

The NFVO resource management unit 13 functions as a connection unit that connects the catalog DB 17 and the instance DB 18, and manages a resource of the NFVO as an NFVO resource. The NFVO is an orchestrator for controlling a network function virtualisation (NFV). For example, the NFVO may template a VNF including a plurality of instances and provide a VNF placement policy function. The NFV is a virtual network function obtained by virtualizing a network functionality.

The NFVO resource management unit 13 can manage a catalog serving as a template of the NS. The other system U1 can acquire a desired catalog from the NFVO resource management unit 13. The other system U1 can readily create a desired order for a particular NS by inputting a predetermined item (including an input parameter) by using the acquired catalog. There are one or more catalogs managed by the NFVO resource management unit 13, and such a catalog is added, deleted, updated, or provided, as necessary. The catalog managed by the NFVO resource management unit 13 is stored in the catalog DB 17. The catalog will be described in detail below.

The NFVO resource management unit 13 can manage an instance of an NS managed by the management apparatus M. Examples of the instance of the NS include, but are not limited to, an instance in which the NS itself is instantiated and an instance in which a VNF used in the NS is instantiated. Information about instances managed by the NFVO resource management unit 13 is stored in the instance DB 18.

The common resource management unit 14 functions as a connection unit that connects the order DB 19 and the notification message DB 20, and manages resources of the server-side apparatuses and resources of the NW-side apparatuses. The common resource management unit 14 may refer to the order DB 19 (described later) and the notification message DB 20 (described later) to arbitrate the resources of the server-side apparatuses and the resources of the NW-side apparatuses. The common resource management unit 14 may output a result of the arbitration to the SVRO 2 and to the NWRO 3 via the scenario management unit 12 to instruct the arbitration of the resources.

The resources of the server-side apparatuses include resources allocated to the server-side apparatuses themselves, and also include resources allocated to links connected to connection points set to the server-side apparatuses.

The resources of the NW-side apparatuses include resources allocated to the NW-side apparatuses themselves, and also include resources allocated to links connected to connection points set to the NW-side apparatuses. The links also include virtual links (VL). If the links connected to the connection points set to the server apparatuses and the links connected to the connection points set to the NW-side apparatuses are the same, the links can be used as a resource of the server-side apparatuses, for example. Alternatively, the links can be used as a resource of the NW-side apparatuses.

The opposing IF 15 is an IF for the E2EO 1 to exchange information with the SVRO 2. The opposing IF 16 is an IF for the E2EO 1 to exchange information with the NWRO 3.

The catalog DB 17 stores a catalog managed by the NFVO resource management unit 13. The instance DB 18 stores information about an instance managed by the NFVO resource management unit 13 (for example, an instance ID to identify an instance and a type of instance).

The order DB 19 stores an order acquired from the other system U1. The order DB 19 may record an acquisition history of an order to be stored.

The notification message DB 20 stores a message exchanged between apparatuses (the server-side apparatuses and the NW-side apparatuses) when the NS managed by the management apparatus M is provided. The notification message DB 20 can record an acquisition history of a message to be stored.

Details of Catalog

Examples of the catalog managed by the NFVO resource management unit 13 include, but are not limited to, elements such as the NS Descriptor (NSD), the VNF Descriptor (VNFD), a Physical Network Function Descriptor (PNFD), a VL Descriptor (VLD), and a VNF Forwarding Graph Descriptor (VNFFGD). As illustrated in FIG. 1, the catalog DB 17 stores therein a plurality of types of the NSDs (c1), a plurality of types of the VNFDs (c2), a plurality of types of the PNFDs (c3), a plurality of types of the VLDs (c4), and a plurality of types of the VNFFGDs (c5).

The NSD (c1) is a portion in which a configuration of the NS is described. The NSD (c1) holds information required to identify and construct the NS, information referencing the VNFD (c2), the PNFD (c3), the VLD (c4), and the VNFFGD (c5) associated with the NS, and the like.

The VNFD (c2) is a portion in which an application (VNF) utilized in the NS is described. The VNFD (c2) holds information required to identify and construct the VNF. The PNFD (c3) is a portion in which a physical function utilized in the NS (NW function provided by the server-side apparatuses and the NW-side apparatuses (Physical Network Function (PNF)) is described. The PNFD (c3) holds information required to identify and construct the PNF. The VLD (c4) is a portion in which a virtual link (VL) utilized in the NS is described. The VLD (c4) holds information required to identify or construct the VL.

The VNFFGD (c5) includes a portion in which a cooperation of a plurality of applications (VNFs) utilized in the NS is described. The cooperation of the applications means connecting a plurality of (VNFs) to provide one function. The VNFFGD (c5) holds information for identifying the VNFFGD (c5), link information between the cooperated VNFs, information for identifying the VLD (c4) and the VNFD (c2) associated with the VNFFGD, and the like.

The NSD (c1) is prepared for each NS, for example, for each service such as an ISP connection service or a dedicated line service, and can be expressed by a combination of the VNFD (c2), the PNFD (c3), the VLD (c4), and the VNFFGD (c5). The other system U1 may input an input parameter into the management apparatus M to readily create an order such as a desired NS generation request. Upon creation of the order, the other systems U1 basically selects a catalogue consistent with the NS configuration from the catalogue DB 17.

Details of NSD

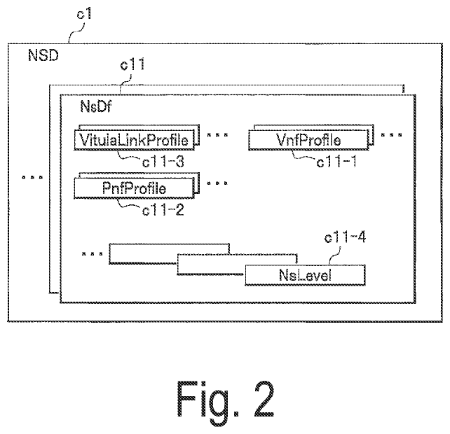

As illustrated in FIG. 2, the NSD (c1) includes a plurality of types of NS Development Flavours (NsDfs) (c11). The NsDf (c11) is a collection of information (information set defining a group of constituent elements of the NS) indicating a virtual link (VL) connection configuration when the VNF is instantiated. In the present embodiment, the NsDf may be abbreviated as “Development Flavour” or “Flavour”.

The NsDf (c11) includes, as an NsDf object to be controlled by the other system U1, a plurality of VnfProfiles (c11-1), a plurality of PnfProfiles (c11-2), a plurality of VirtualLinkProfiles (c11-3), and a plurality of NsLevels (c11-4).

There are prepared a plurality of types of NsDfs that can be selected by the other system U1 for one NSD (c1).

The VnfProfile (c11-1) indicates, as a component (Profile) of the Development Flavour, a specific VNF that configures the NS.

The PnfProfile (c11-2) indicates, as a profile of the Development Flavour, a specific PNF that configures the NS.
The VirtualLinkProfile (c11-3) indicates, as a profile of the Development Flavour, a specific VL that configures the NS.

The NsLevel (c11-4) is an indicator for classifying the NS, for example, an indicator determined from one or more VNFs, one or more VLs, or one or more nestedNSs (recursive NSs) included in the NS. The NsLevel (c11-4) realizes, as a profile of the Development Flavour, a band designation of VLProfile (profile representing the VL) held by CompositeNS (composite NS) and designation of a number of instances (numberOfInstances) of the nestedNS.

To control specific constituent elements (the VNF, the PNF, and the VL) of the NS to be controlled, the other system U1 uses, as a catalog, the NSD to identify the NS to transmit an order. At that time, the other system U1 may select one NsDf out of the plurality of types of NsDfs provided in the NSD to designate and control the VNF, the PNF, and the VL, which are indicated as the NsDf object provided in the selected NsDf.

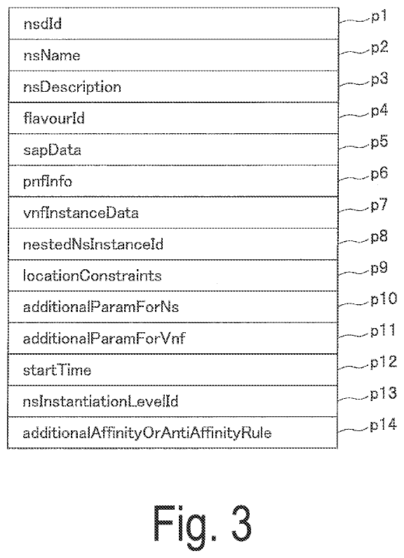

For example, when generating the NS or instantiating the NS (in a Create NS operation/Instantiate NS operation), the other system U1 includes a parameter that can be designated in the generation of the NS or the instantiation of the NS into the order (the NS generation order or the NS instantiating order) and transmits the order to the management apparatus M. As shown in a comparative example of FIG. 3, a parameter that can be designated in the generation of the NS or the instantiation of the NS (Create NS Identifier/Instantiate NS) typically includes nsdld (p1), nsName (p2), nsDescription (p3), flavourId (p4), sapData (p5), pnfInfo (p6), vnfInstanceData (p7), nestedNsInstanceld (p8), locationConstraints (p9), additionalParamForNs (p10), additionalParamForVnf (p11), startTime (p12), nsInstantiationLevelId (p13), and additionalAffinityOrAntiAffinityRule (p14).

The nsdld (p1) indicates an identifier of the NSD.

The nsName (p2) indicates a name for identifying the NSD.
The nsDescription (p3) indicates a description of the NSD.
The flavourId (p4) indicates an identifier of the flavour.

The sapData (p5) specifically indicates a correspondence between a service access point ID (sapId) and Address information, as information on a service access point (SAP) of the NS. Here, the sapId indicates an identifier of the service access point (SAP), and the Address information is, for example, an IP address, a virtual local area network (VLAN)-ID. The pnfInfo (p6) indicates a correspondence between PNFD information, a connection point (CP) of the PNF, and the Address information. Here, the Address information is, for example, an IP address, and a VLAN-ID.

The vnfInstanceData (p7) indicates information of an existing VNF instance. The VNF instance is an instance of the VNF which is one of the constituent elements of the NS. The nestedNsInstanceld (p8) indicates information of an existing NS instance. The NS instance is a virtual network service (including one or more VNFs, one or more VLs, and the like) generated based on the NSD.

The locationConstraints (p9) indicates location constraint information of the VNF. The additionalParamForNs (p10) indicates a type of extended parameter for the NS. The extended parameter for the NS is configured by a list of KeyValuePair (set of strings and numerical values, for example).

The additionalParamForVnf (p11) indicates a type of extended parameter for the VNF. The extended parameter for the VNF includes vnfProfileId (an identifier of the VNF Profile) and additionalParam (an extension region designated in the present embodiment (region where the extended parameter can be described)).

The startTime (p12) indicates a timestamp of a start time at which resource reserving starts.

The nsInstantiationLevelId (p13) indicates an identifier of nsInstantiationLevel defining an NSLevel in a reference NSDF used for a parent NS instantiation context. The Network Service Deployment Flavour (NSDF) represents a template of a configuration during the instantiation of the NS.

The additionalAffinityOrAntiAffinityRule (p14) indicates an additional affinity rule and an anti-affinity rule applied to a VNF to be instantiated in an NS instantiating operation request and existing VNF instances.

The other system U1 typically need to designate the flavourId (p4) to select the NsDf in order to generate the NS or instantiate the NS. This means that an information set of NsDf predefined for the NSD is selected in the NS generation/instantiation operation. Thus, the constituent element of the NS controlled by the other system U1 is limited to a constituent element indicated by the selected NsDf, and it is not possible to perform a detailed designation such as to control another constituent element and to individually control a certain constituent element.

In the present embodiment, a parameter that can be designated in the generation of the NS or the instantiation of the NS is extended, and a parameter by which a component (profile) of the NsDf can be selected is prepared to enable designation of a combination of profiles (group of constituent elements of the NS) in the parameter.

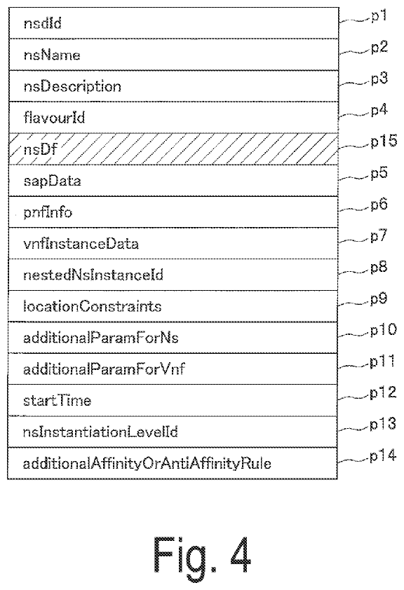

Specifically, as illustrated in FIG. 4, extended parameters obtained by adding the nsDf (P15) (a specific parameter) to the parameters (p1 to p14) already described are employed for parameters that can be designated in the generation of the NS or the instantiation of the NS. The nsDf (p15) is a parameter indicating a constituent element of the NS individually designated by the other systems U1, from among the specific constituent elements of the NS to be controlled. The other system U1 may designate any one of flavourId (p4) and nsDf (p15) of parameters to be included in an order. That is, if utilizing the NsDf defining the NSD, the other system U1 designates the flavourId (p4), and if wishing to individually designate a Profile without utilizing the NsDf defining the NSD, the other system U1 designates the nsDf (p15).

Note that in the NS generation/instantiation operation, the parameter of the nsInstantiationLevelId (p13) may or may not be defined.

In addition, if the individual designation of the Profile by the nsDf (p15) corresponds to a designation not exceeding a predetermined standard defined range, the Profile may be designated by the additionalParamForNs (p10) and the additionalParamForVnf (p11), and may be designated by nsDf (p15).
Further, if a constituent element of an NS is individually designated by the other system U1, the other system U1 aims, for example, a physical resource optimization of the NS, but is not limited to this purpose.

The other system U1 typically need to designate a flavourId (p4) to select an NsDf (c11), and thus, the selection of an NsLevel (c11-4) is premised. For this reason, it is not possible to provide a detailed designation such as to individually designate a numerical value of a band and the like.

In the present embodiment, it is possible to individually designate a numerical value of a band and the like from the nsDf (p15) described above. That is, in the NS generation, the NS instantiation, or an NS Scale, the nsDf (p15) is defined as a parameter allowing for designation and modification of the NsLevel (c11-4).

Note that the designation of the NsLevel (c11-4) may be omitted, and in this case, a default level is applied.

Configuration of NSD by Extended Parameter

The other system U1 transmits an NS generation order including an extended parameter including the nsDf (p15), to the management apparatus M. The nsDf (p15) includes a constituent element of the NS, which is individually designated by the other systems U1. The management apparatus M configures an NSD with reference to the nsDf (p15).

Here, there are two following types of schemes where the NSD is configured based on the nsDf (p15):

Scheme [1]: Uniquely define each Descriptor and select a generation target in an Instantiate NS operation (operation for executing an NS instantiation).
Scheme [2]: Uniquely define a remaining type of Descriptor according to the VNFFGD and select a generation target in an Instantiate NS operation.

In the scheme [1], the management apparatus M defines all the VNFDs provided in the configured NSD and generates all the VNFs based on the defined VNFDs. The management apparatus M also defines all the PNFDs provided in the configured NSD, and generates all the PNFs based on the defined PNFDs. The management apparatus M also defines all the VLDs provided in the configured NSD and generates all the VLs based on the defined VLDs. The management apparatus M also defines all the VNFFGDs provided in the configured NSD, and generates all the VNFFGs based on the defined VNFFGDs.

Note that a service access point (SAP) in which the NS access point is described may be included as a constituent element of the NS included in the nsDf (p15). In this case, the management apparatus M may define all service access point Descriptors (SAPD) provided in the SAP and generate all the SAPs based on the defined SAPDs.

Furthermore, the nestedNS may be included as a constituent element of the NS included in the nsDf (p15). In this case, the management apparatus M may define all nestedNSDs (nestedNS Descriptors) provided in the nestedNS included in the NS, and generate all the nestedNSs based on the defined nestedNSDs.

The scheme [2] is a scheme based on the assumption that an application of each VNFFGD is preset. In this assumption, each VNFFGD is defined to be associated with a Descriptor other than the CP and the VNFFGD. Thus, the management apparatus M configures the NSD upon designing to which VNFFGD each Descriptor belongs. Specifically, if even NS constituent elements having the same specification are assigned and made to belong to a different VNFFGD, the management apparatus M imparts a different ID to each of the NS constituent elements and registers the NS constituent elements with the corresponding Descriptor.

The management apparatus M may determine the instantiation of each of constituent elements of the NS defined by the NSD during an execution of an Instantiate NS operation, based on the following parameters included in an order from the other system U1, for example:
flavourId (p4) (in a case where a flavour predefined in the NSD is used).
   sapData (p5).
   nsInstantiationLevelId (p13) (in a case where NsLevel predefined to the NsDf in the NSD (reference sign c11-4 in FIG. 2) is used).
   Information designating presence or absence of the instantiation of the VNFFGD (in a case where the scheme [1] is employed).
   An assembly of constituent elements of the NS included in the nsDf (p15) (in a case where the flavour predefined in the NSD is not used) (assembly of constituent elements of the NS (information set corresponding to the NsDf) may include Dependencies. The Dependencies is an indication of an order when one or more VNFs associated with other VNF Profiles are instantiated, and an order when one or more nestedNSs associated with other NS Profiles are instantiated).
   Information set corresponding to NsInstantiationLevel (Level identified by the nsInstantiationLevelId (p13)) included in the nsDf (p15) (in a case where Level predefined in the NSD is not used). The information set corresponds to, for example, the number of instances and bitrate directly designated by the other system U1.

Method of Realizing Extended Operation

In the present embodiment, for an operation for an NS generation and an NS update (UpdateNS) to the management apparatus M from the other system U1, it is necessary to realize an extended operation with a Flavour configuration not set to a predefining NSD or an InstantiationLevel setting not set to the NSD (setting of an identifier of an instantiation level of VNF DF used for instantiation). The following methods [1] to [3] are provided for a method of realizing the extended operation.

Method [1]: Utilize additionalParamForNs (p10) or additionalParamForVnf (p 11) (in the UpdateNS, there is no additionalParamForNs (p10) as a parameter, and thus, extension is required so that additionalParamForNs (p10) exists).

Method [2]: Perform UpdateNS in which the latest NSD obtained after the NSD is updated is designated.
Method [3]: Add a parameter in both the InstantiateNS and the UpdateNS.

The processing of an order for generating and updating the NS by using the extended parameter including the nsDf (p15) (FIG. 4) is used, which is described above in the present embodiment, corresponds to the method [3]. It is also possible to realize an operation in which the method [1] or [2] is combined, as appropriate, with the method [3].

Note that, in terms of the VNF, the extended parameter and the metadata are defined in two information elements out of the predefined information elements configuring the VNFD, that is, in each of configurableProperties and modifiableAttributes.

The configurableProperties as the information element of the VNFD is an informational element that defines the configurableProperties of the VNF, and the VNF instance is a property that is modifiable by a Virtual Network Function Manager (VNFM).
The modifiableAttributes as the information element of the VNFD is a VNF-specific extension region (region where an extended parameter can be described) (VNF-specific extension and metadata attribute), which can be described in a ModifyVnfInfo operation. The modifiableAttributes enables VNF extended control outside of the VNFD definition (to improve performance of the subject VNF beyond a performance range defined in the VNFD).

The other system U1 may designate the additionalParamForVnf (p11) already described above in the Instantiate NS operation. Here, Attribute (attribute) defined in the configurableProperties of the VNFD may be employed for the Attribute (attribute) configurable in the additionalParamForVnf (p11).

In a case of performing an NS update (Update NS operation), the other system U1 includes a parameter that can be designated in the NS update into an order (NS update order) and transmits the order to the management apparatus M. Here, the parameter that can be designated in the NS update includes modifyVnfInfoData and modifyVnfConfigData.

The modifyVnfInfoData indicates information required to be modified, out of the information about the VNF instance.
The modifyVnfConfigData indicates a configuration parameter that can be modified by the VNF to be operated.

In the Update NS operation, the other systems U1 may designate the modifyVnfInfoData. Here, Attribute (attribute) defined in the modifiableAttributes of the VNFD may be employed for the Attribute (attribute) configurable in the modifyVnfInfoData. Thus, the other systems U1 may execute the VNF extended control outside of the VNFD definition.

Furthermore, in terms of the NS, the NSD does not include an information element corresponding to an information element: configureableProperties included in the VNFD, and thus, it is not possible to define the extended metadata and the extended parameter using the VNFD. However, in the Instantiate NS operation, the other system U1 may designate the additionalParamForNs (p10), and thus, it is possible to define the extended parameter and metadata. Note that the other system U1 cannot define the extended parameter over the entire NS in the Update NS operation.

Process

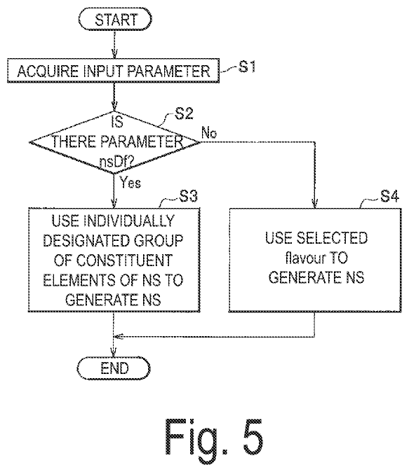

Next, an NS generation order processing that is a processing performed by the management apparatus M according to the present embodiment will be described. As illustrated in FIG. 5, the NS generation order processing starts when the other system U1 transmits an NS generation order to the management apparatus M.

Firstly, in the management apparatus M, an input parameter included in the received NS generation order is acquired by the request reception unit 11 of the E2EO 1 (step S1). Next, the management apparatus M determines whether an nsDf (p15) being an extended parameter is present in the acquired input parameter (step S2) by the scenario management unit 12 of the E2EO 1, according to the NS generation scenario 12a.

If the nsDf (p15) is present (Yes, in step S2), the scenario management unit 12 of the E2EO 1 in the management apparatus M generates an NS by using a group of constituent elements (that is, Profiles) of the NS individually designated by the other system U1 (step S3), according to the NS generation scenario 12a, and the NS generation order processing ends. The specific processing of generating the NS by the management apparatus M may include, for example, allocating, by the SVRO 2, a resource to a server-side apparatus designated by a catalog previously selected and acquired from the catalog DB 17 for the other system U1 to generate an NS generation order, allocating, by the NWRO 3, a resource to an NW-side apparatus designated by the catalog, and deploying a VNF, a VL, and the like being a group of constituent elements of the NS at a predetermined location on a NW (slice) obtained by partially virtualizing the existing NW. In step S3, the deployed group of constituent elements of the NS is individually designated by the other system U1.

Specific other processes of generating the NS are described in Patent Literature 1, for example.

On the other hand, if the nsDf (p15) is not present in the input parameter (No, in step S2), the management apparatus M generates an NS by the scenario management unit 12 of the E2EO 1 by using a flavour selected by the other system U1, according to the NS generation scenario 12a (step S4), and the NS generation order processing ends. The selected flavour is a flavour identified by a flavourId (p4) (FIG. 4). In step S4, a VNF, a VL, and the like being a constituent element of the NS designated by the selected flavour are deployed at a predetermined location on the slice.

According to the present embodiment, if the nsDf (p15) that enables individual designation of a group of constituent elements of an NS is included in an NS generation order, it is possible to provide a means of performing a detailed designation of a group of constituent elements of the NS, which is otherwise impossible to realize in the selection of the NS Deployment Flavor, to an external apparatus.

It is thus possible to improve performance of NS management.

Others

An extended parameter such as the nsDf (p15) may be used not only to the NS generation order but also to various orders such as an NS update order and an NS deletion order.

A technique obtained by suitably combining various techniques described in the present embodiment may be implemented.

Software described in the present embodiment may be implemented as hardware, and hardware may be implemented as software.
In addition, hardware, software, the flowchart, and the like can be suitably changed without departing from the spirit of the present disclosure.

### REFERENCE SIGNS LIST

M Management apparatus
U Upper level apparatus (external apparatus)
U1 Another system (external apparatus)
1 E2EO (service management unit)
2 SVRO (server resource management unit)
3 MWRO (NW resource management unit)
11 Request reception unit
12 Scenario management unit
13 NFVO resource management unit
14 Common resource management unit
15, 16 Opposing IF
17 Catalog DB
18 Instance DB
19 Order DB
20 Notification message DB

1. A management apparatus for managing a network service (NS) constructed on a network (NW) including a core NW serving as a virtualization area and an access NW serving as a non-virtualization area, wherein the NW includes a server-side apparatus and an NW-side apparatus when the NS is provided, the management apparatus comprising:
a request reception unit configured to acquire, from an external apparatus, an NS generation order including an input parameter required for designating the server-side apparatus and the NW-side apparatus; and
a catalog database (DB) configured to store a catalog serving as a template of the NS,
wherein the catalog includes an NS Descriptor (NSD) that is a portion where a configuration of the NS is described and that has a plurality of types of information sets for defining a group of constituent elements of the NS in a selectable manner, and
wherein the management apparatus further comprises a scenario management unit configured to:
generate, based on a specific parameter for individually designating a group of constituent elements of the NS by the external apparatus without selecting the plurality of types of information sets being included in the input parameter, the NS by using the individually designated group of constituent elements of the NS, and
generate, based on the specific parameter not being included in the input parameter, the NS by using an information set selected by the external apparatus.

2. The management apparatus according to claim 1, wherein the catalog further includes:
a portion where an application utilized in the NS is described, a portion where a physical function utilized in the NS is described, a portion where a connection relationship between applications utilized in the NS is described, and a portion where a link utilized in the NS is described.

3. A network management method in a management apparatus for managing an NS constructed on an NW including a core NW serving as a virtualization area and an access NW serving as a non-virtualization area, wherein the NW includes a server-side apparatus and an NW-side apparatus when the NS is provided, the management apparatus includes a catalog DB that is configured to store a catalog serving as a template of the NS, and the catalog includes an NSD that is a portion where a configuration of the NS is described and that includes a plurality of types of information sets for defining a group of constituent elements of the NS in a selectable manner, the method comprising:
acquiring, from an external apparatus, an NS generation order including an input parameter required for designating the server-side apparatus and the NW-side apparatus;
generating, based on a first parameter in which a group of constituent elements of the NS is individually designated by the external apparatus without selecting the plurality of types of information sets being included in the input parameter, the NS by using the individually designated group of constituent elements of the NS; and
generating, based on the first parameter not being included in the input parameter, the NS by using an information set selected by the external apparatus.

4. The network management method according to claim 3, wherein the catalog further includes:
a portion where an application utilized in the NS is described, a portion where a physical function utilized in the NS is described, a portion where a connection relationship between applications utilized in the NS is described, and a portion where a link utilized in the NS is described.
